(19) United States
(12) Patent Application Publication
(10) Pub. No.: US 2007/0229150 A1
(43) Pub. Date: Oct. 4, 2007

(54) Low-voltage regulated current source

(75) Inventor: Sherif Galal, Irvine, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/541,549

(22) Filed: Oct. 3, 2006

Related U.S. Application Data
(60) Provisional application No. 60/787,489, filed on Mar. 31, 2006.

(51) Int. Cl. G05F 1/10

(52) U.S. Cl. 327/543

(57) ABSTRACT

A low voltage regulated current source includes a feedback amplifier that forces a node voltage in both branches of the current mirror to equal to each other, by adjusting voltages in two branches of the current mirror to be equal to each other. The low voltage current mirror also has a higher output impedance compared to other current mirrors.

### CROSS REFERENCE TO RELATED APPLICATIONS

This application claims the benefit of U.S. Provisional Application No. 60/787,489 filed Mar. 31, 2006, which is incorporated herein by reference in its entirety.

### FIELD OF THE INVENTION

The present invention relates to a current source, specifically a low-voltage regulated current source.

### BACKGROUND OF THE INVENTION

Modern low power integrated circuits typically operate with very low supply voltages. This creates a challenge for current sources in low power integrated circuits to supply a constant current because low voltage power supplies tend to have voltage variations due to the effects and power requirements of other circuit components. A widely used current source in integrated circuits is a current mirror. However, most current mirrors are susceptible to voltage and load variations, thus making them undesirable for use in low power integrated circuits. For low power integrated circuits, it is desirable to have a constant current source that is not susceptible to varying supply voltages and load requirements.

### BRIEF SUMMARY OF THE INVENTION

In one aspect, there is provided a current mirror circuit that comprises a reference current side, a load current side, and a feedback circuit. The reference current side of the current mirror is configured to generate a reference current. The reference current side further includes a plurality of transistors. The load current side is configured to generate a load current proportional to the reference current. The load current side includes a first transistor coupled to a second transistor of the plurality of transistors of the reference current side. The feedback circuit is configured to provide a voltage difference between a terminal of the first transistor of the load current side and a terminal of the second transistor to a terminal of a third transistor of the plurality of transistors.

In another aspect of the present invention, the current mirror circuit uses an amplifier as a feedback circuit. The circuit further includes a first input, a second input, and an output of the amplifier being coupled to the terminal of the first transistor of the load current side, the terminal of the second transistor of the reference current side, and the terminal of the third transistor of the reference current side, respectively, wherein the terminal of the third transistor is a gate terminal. The circuit further includes a gate terminal of the first transistor of the load current side being coupled to a gate terminal of the second transistor of the reference current side. The current mirror circuit further includes a drain terminal of the third transistor being coupled to the gate terminal of the second transistor.

An advantage of the present invention is that the current source has a high output impedance.

A further advantage of the present invention is that the current source has a low compliance voltage, thus making it desirable for use in low voltage applications.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The present invention is described with reference to the accompanying drawings.

FIGS. 1-3 illustrate circuit diagrams of known current mirrors;

FIG. 4 illustrates a circuit diagram of a current mirror according to an embodiment of the present invention.

FIG. 5 illustrates a circuit diagram of a current mirror according to another embodiment of the present invention.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described. An embodiment of the present invention is now described. While specific methods and configurations are discussed, it should be understood that this is done for illustration purposes only. A person skilled in the art will recognize that other configurations and procedures may be used without departing from the spirit and scope of the invention.

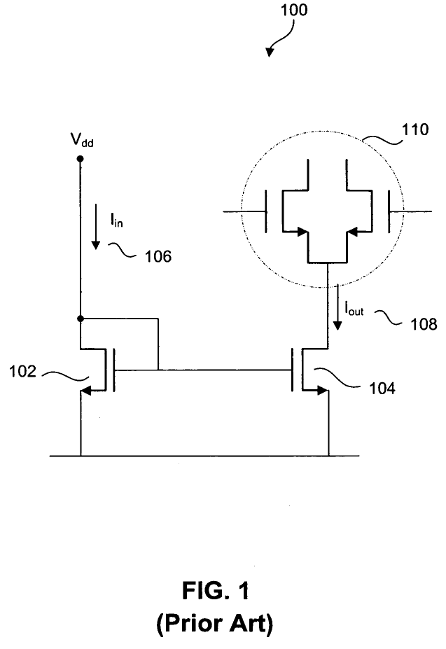

FIG. 1 illustrates a commonly used current mirror 100 that includes transistors 102 and 104. On a high level, when the source current of transistor 102 is held constant, the drain current of transistor 102 will remain constant. This holds true as long as the drain-to-source voltage (V_{DS}) is sufficiently large to keep transistor 102 in active mode (non-triode mode). In current mirror 100, the gates of transistors 102 and 104 are tied together, which are also tied to the drain of transistor 102. In this way, transistor 104 can replicate input current (Iᵢₙ) 106 and produce a proportional output current (Iₒᵤₜ) 108. Current mirror 100 can be configured to produce Iₒᵤₜ 108 at various input-to-output ratios, 1:n. The input-to-output ratios are controlled by the relative transistor sizes.

The design of current mirror 100 is elegant, but mirror 100 is susceptible to a varying output current due to varying supply voltage and load power requirements. For example in mirror 100, when the power requirements of a load 110 changes, the V_{DS} of transistor 104 will also change. When this occurs, the V_{DS} of transistor 104 will be different with respect to the V_{DS} of transistor 102. This causes Iₒᵤₜ 108 to be non-proportional to Iᵢₙ 106. In the case where Iₒᵤₜ is designed to be nominally equal to Iᵢₙ, a difference in the V_{DS} of transistor 102 and V_{DS} of transistor 104 will cause Iᵢₙ and Iₒᵤₜ to be unequal.

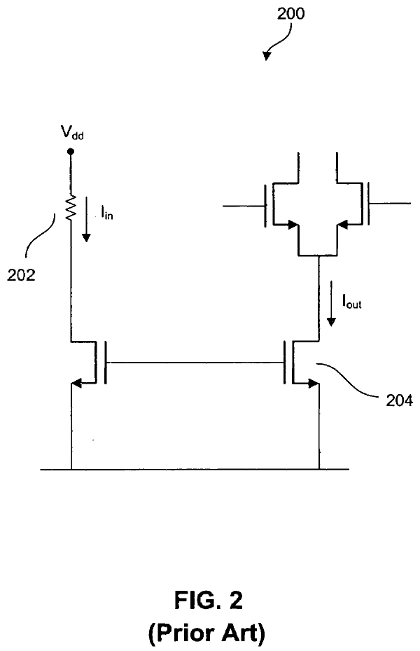

FIG. 2 illustrates a current mirror 200 similar to current mirror 100. In current mirror 200, a resistor 202 is added to the input current side of current mirror 200 to better control the input current. In this way, the output current is also better controlled due to the added input current stability. However, current mirror 200 also suffers from the problem of varying output current due to varying load requirements that cause the V_{DS} of transistor 204 to change.

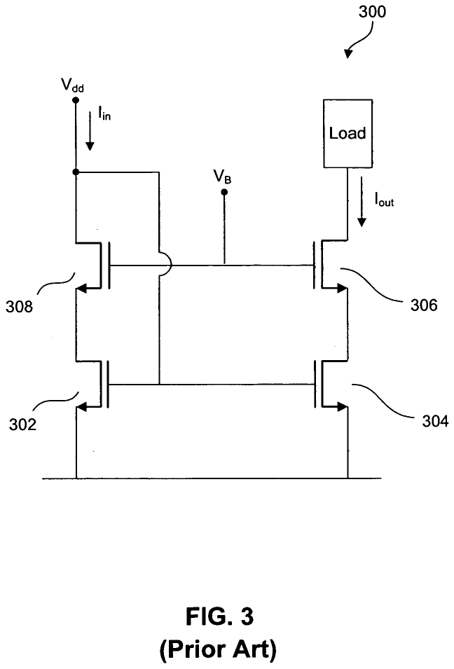

FIG. 3 illustrates a current mirror 300 utilizing cascode stages to increase the output impedance and improve current matching. Current mirror 300 includes transistors 302, 304, 306, and 308. Transistor 304 is the current source. Transistor 306 helps keep the voltage at the drain of transistor 304 constant. In this way, the output current can be better controlled. However, current mirror 300 is not without disadvantages. Current mirror 300 requires a relatively large voltage source and is particularly sensitive to the input voltage swing. This makes current mirror 300 undesirable for use in low power integrated circuits.

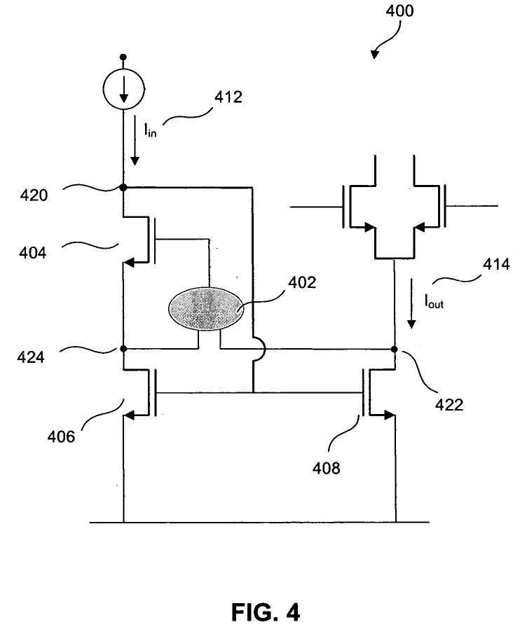

FIG. 4 illustrates an improved current mirror 400 according to an embodiment of the present invention. Current mirror 400 utilizes a cascode stage at the input side. Current mirror 400 includes a feedback circuit 402, transistors 404, 406, and 408, and a current source 410. In current mirror 400, an input current (Iᵢₙ) 412 is replicated as an output current (Iₒᵤₜ) 414 using the transistor pair 406 and 408, both of which are identical. Current mirror 400 can be configured to produce any desired Iᵢₙ to Iₒᵤₜ ratio.

As shown in FIG. 4, the gates of transistors 404 and 408 are both coupled to node 420, which is the drain terminal of transistor 402. When node 420 is driven by Iᵢₙ 412, transistor 406 will allow Iᵢₙ 412 to pass through its drain and source. At the same time, transistor 408 mirrors Iᵢₙ 412 and produces an equivalent current Iₒᵤₜ 414 because the voltage potential at its gate is the same as the voltage potential at the gate of transistor 406 and node 420.

In current mirror 400, as shown in FIG. 4, output node 422 is coupled to a differential pair. It should be noted that any other load circuit can be coupled to output node 422. The voltage at node 422 (Vₒᵤₜ) is often time controlled by the load requirement of the differential pair or load circuit. A change in the differential pair load requirement will typically cause a change in the output voltage, Vₒᵤₜ. This change in the output voltage causes an imbalance in the current mirror system. For example, when Vₒᵤₜ changes, the drain-to-source voltage of transistor 408 also changes, making it unequal to the drain-to-source voltage of transistor 406. When this occurs, Iₒᵤₜ 414 will be different from Iᵢₙ 412. To prevent the above problem from occurring, feedback circuit 402 is used to drive the gate of transistor 404, as shown in FIG. 4.

On a high level, feedback circuit 402 compares the voltage at nodes 422 and 424. Based the voltage comparison, feedback 402 drives the gate of transistor 404 such that the voltage difference between nodes 422 and 424 will be substantially zero. This is achieved by biasing the gate voltage of transistor 404 such that the voltage drop across transistor 404 causes the voltage at node 424 (source voltage) to be the same as the voltage at node 422.

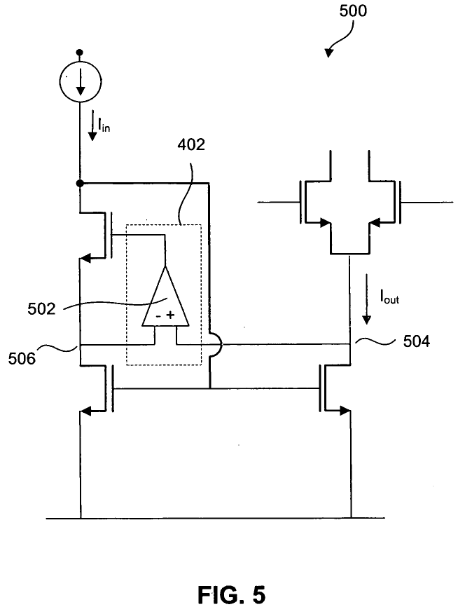

FIG. 5 illustrates a current mirror 500 that is one embodiment of the current mirror 400, wherein an operational amplifier 502 is used as the feedback circuit. In current mirror 500, the non-inverting and inverting inputs of amplifier 502 is coupled to the output node 504 and node 506, respectively. This input-to-node coupling arrangement could also be reversed (i.e. inverting input coupled to node 504). Additionally, the output of amplifier 502 is coupled to the gate of transistor 510.

One advantage of using operational amplifier 502 as a feedback circuit is the fact that op-amp draws very little input current (in the range of nano and pico amps, as a practical matter). As a result, the current mirror system is not affected by the present of amplifier 502 (e.g. the output current at node 504 is not affected). When amplifier 502 senses a voltage difference between nodes 504 and 506, amplifier 502 will drive the gate of transistor 510 such that voltages at nodes 504 and 506 will equalize. In this way, the headroom or operation voltage range of current mirror 500 is increased because of the stability added to the current mirror system by amplifier 502.

Although FIGS. 4-5 show current mirrors 400 and 500 constructed with npn transistors, it should be understood by one skilled in the art that current mirrors 400 and 500 may also be constructed with pnp transistors such that it would not depart from the spirit and scope of the invention.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

We claim:

1. A current mirror circuit comprising:
a reference current side configured to generate a reference current, the reference current side having a plurality of transistors;
a load current side configured to generate a load current proportional to the reference current, the load current side having a first transistor coupled to a second transistor of the plurality of transistors of the reference current side; and
a feedback circuit configured to provide a voltage difference between a terminal of the first transistor of the load current side and a terminal of the second transistor to a terminal of a third transistor of the plurality of transistors.

2. The current mirror circuit of claim 1, wherein the feedback circuit is an amplifier.

3. The current mirror circuit of claim 2, wherein the amplifier has a first input, a second input, and an output, the first input is coupled to the terminal of the first transistor of the load current side, the second input is coupled to the terminal of the second transistor of the reference current side, the output is coupled to the terminal of the third transistor of the reference current side.

4. The current mirror circuit of claim 3, wherein the first input is a non-inverting input and the second input is an inverting input.

5. The current mirror circuit of claim 1, wherein the terminal of the first transistor and the terminal of the second transistor are drain terminals.

6. The current mirror circuit of claim 1, wherein a gate terminal of the first transistor of the load current side is coupled to a gate terminal of the second transistor of the reference current side.

7. The current mirror circuit of claim 1, wherein the terminal of the third transistor is a gate terminal.

8. The current mirror circuit of claim 1, wherein a drain terminal of the third transistor is coupled to the gate terminal of the second transistor.

9. A current source comprising:
a first transistor have a first and second terminals;
a second transistor coupled to the second terminal of the first transistor;
a third transistor having a third and a fourth terminal, the third terminal coupled to the second transistor, the fourth terminal coupled to a load circuit; and
a circuit outputting a voltage difference between the second terminal and the fourth terminal to the first terminal.

10. The current source of claim 9, wherein the circuit is an amplifier.

11. The current source of claim 10, wherein the amplifier has a first input, a second input, and an output, the first input is coupled to the fourth terminal, the second input is coupled to the second terminal, the output is coupled to the first terminal.

12. The current source of claim 11, wherein the first input is a non-inverting input and the second input is an inverting input.

13. The current source of claim 1, wherein the second node is a drain node and the second terminal is a source terminal.

14. The current source of claim 1, wherein a gate terminal of the second transistor is coupled to a gate terminal of the third transistor.

15. The current source of claim 1, wherein the first terminal is a gate terminal.

16. The current source of claim 1, wherein a drain terminal of the first transistor is coupled to the gate terminal of the second transistor.
